(19) United States
(12) Patent Application Publication
(10) Pub. No.: US 2010/0045946 A1
(43) Pub. Date: Feb. 25, 2010

(54) Projection Apparatus

(76) Inventors: CHIA-TIEN CHEN, Hsin-Chu (TW); WEI-JU CHEN, Hsin-Chu (TW)

Correspondence Address: HDLS Patent & Trademark Services, P.O. BOX 220746, CHANTILLY, VA, 20153-0746, US

(21) Appl. No.: 12/268,514

(22) Filed: Nov. 11, 2008

(30) Foreign Application Priority Data
Aug. 20, 2008 (TW) 097131805

(51) Int. Cl. G03B 21/14

(52) U.S. Cl. 353/119

(57) ABSTRACT

A projection apparatus includes a housing, a switch unit, a projection module, a circuit unit and a remote controller. The housing has an accommodation space and a containing groove. The switch unit is arranged in the containing groove. The projection module and the circuit unit are arranged in the accommodation space, and the circuit unit is electrically connected to the projection module and the switch unit. The remote controller is adapted to be contained in the containing groove and be taken out from the containing groove. When the remote controller is contained in the containing groove, the remote controller contacts the switch unit, and the circuit unit enables and disables the projection module according to a contact relation between the remote controller and the switch unit. The remote controller of the projection apparatus is easy to be contained.

### BACKGROUND

1. Field of the Invention

The present invention relates to a display apparatus, and more particularly to a projection apparatus.

2. Description of the Related Art

FIG. 1 is a schematic view of a conventional projection apparatus. Referring to FIG. 1, the conventional projection apparatus 100 includes a projection main body 110 and a remote controller 120. The projection main body 110 is configured for projecting an image onto a screen, and the remote controller 120 is configured for operating the projection main body 110, such as enabling the projection main body 110, disabling the projection main body 110 and adjusting the brightness and contrast of the image projected by the projection main body 110.

In the conventional projection apparatus, since the projection main body 110 does not have any containing portion configured for containing the remote controller 120 arranged therein and, the projection main body 110 and the remote controller 120 need to be accommodated independently. Therefore, the remote controller 120 is inconvenient to be contained, and is prone to be lost.

What is needed is providing a projection apparatus, which may solve the above problems.

### BRIEF SUMMARY

The present invention relates to a projection apparatus capable of containing a remote controller easily.

A projection apparatus in accordance with an exemplary embodiment of the present invention is provided. The projection apparatus includes a housing, a switch unit, a projection module, a circuit unit and a remote controller. The housing has an accommodation space and a containing groove. The switch unit is arranged in the containing groove. The projection module and the circuit unit are arranged in the accommodation space, and the circuit unit is electrically connected to the projection module and the switch unit. The remote controller is adapted to be contained in the containing groove and be taken out from the containing groove. When the remote controller is contained in the containing groove, the remote controller contacts the switch unit, and the circuit unit enables and disables the projection module according to a contact relation between the remote controller and the switch unit.

In the projection apparatus of the embodiment of the present invention, since the housing has the containing groove configured for containing the remote controller, the remote controller is easy to be contained to prevent the remote controller from being lost. In addition, since the containing groove includes the switch unit arranged therein and the circuit unit enables and disables the projection module according to the contact relation between the remote controller and the switch unit, the projection apparatus is convenient in use.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the embodiments of the invention, and are incorporated in and constitute part of this specification. The drawings illustrate embodiments of the invention and, together with the description, serve to explain the principles of the invention.

FIG. 1 is a schematic view of a conventional projection apparatus.

FIG. 2 is a schematic three dimensional view of a projection apparatus in accordance with an exemplary embodiment of the present invention.

FIG. 3 is a block diagram of the projection apparatus of FIG. 2.

FIG. 4A is a schematic view showing that a remote controller is arranged out of the containing groove of a housing in accordance with an exemplary embodiment of the present invention.

FIG. 4B is a schematic view showing that the remote controller is arranged in the containing groove of the housing in accordance with an exemplary embodiment of the present invention.

FIG. 5 is a schematic side view of the projection apparatus of FIG. 2.

FIG. 6 includes two different schematic three dimensional views of the remote controller and a schematic perspective view of the containing groove of the housing in accordance with an exemplary embodiment of the present invention.

FIG. 7A is a schematic view showing that the remote controller is arranged out of the containing groove of the housing in accordance with another exemplary embodiment of the present invention.

FIG. 7B is a schematic view showing that the remote controller is arranged in the containing groove of the housing in accordance with another exemplary embodiment of the present invention.

FIG. 7C is a schematic view showing that a portion of the remote controller is arranged in the containing groove of the housing in accordance with another exemplary embodiment of the present invention.

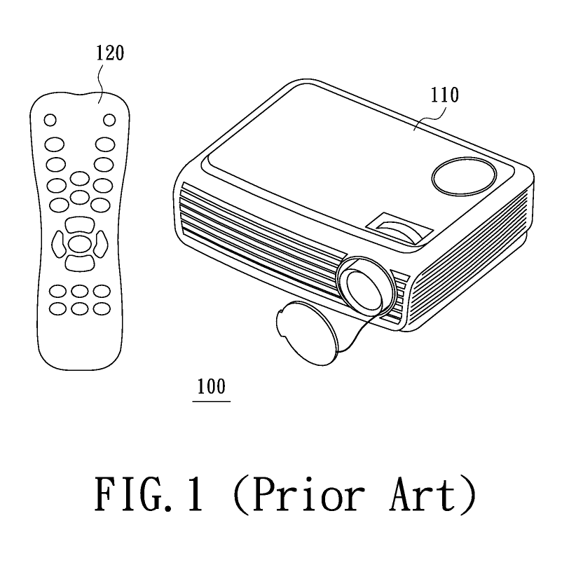

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

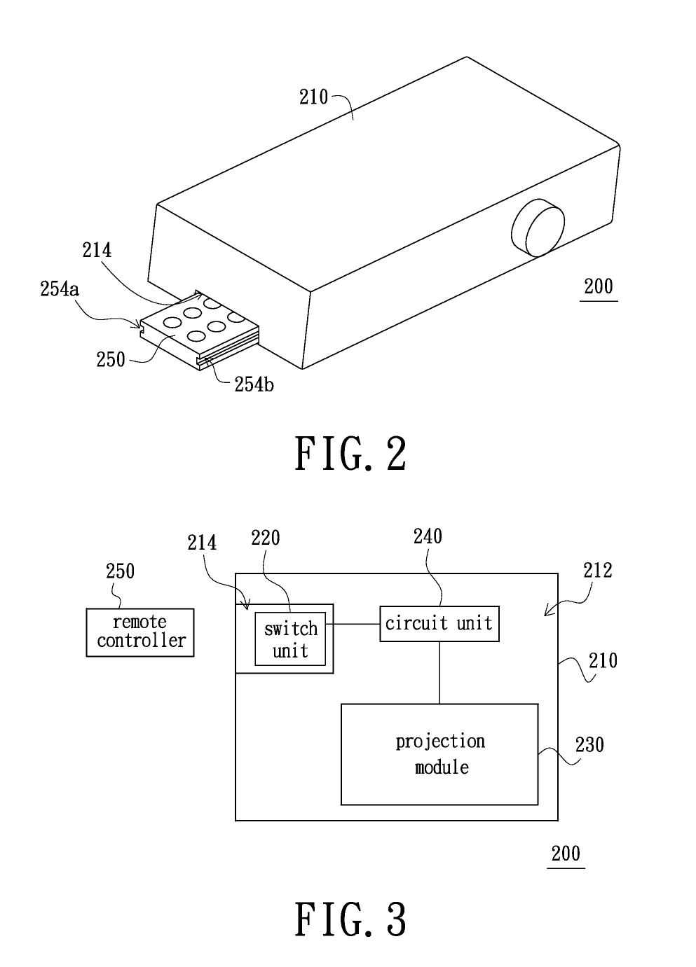

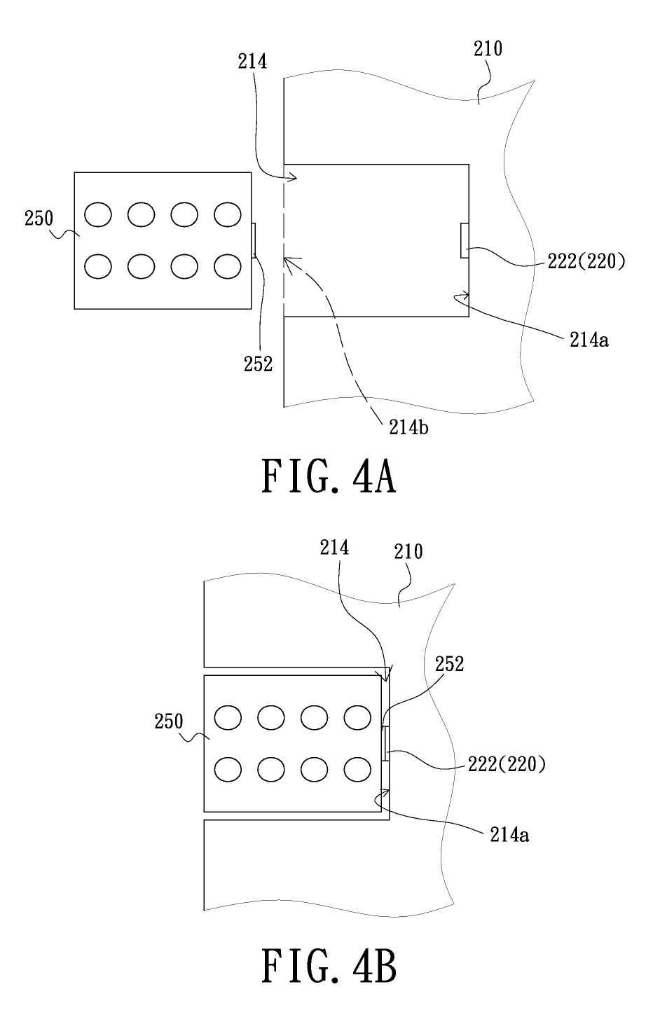

FIG. 2 is a schematic three dimensional view of a projection apparatus in accordance with an exemplary embodiment of the present invention. FIG. 3 is a block diagram of the projection apparatus of FIG. 2. Referring to FIGS. 2 and 3, the projection apparatus 200 of the present exemplary embodiment includes a housing 210, a switch unit 220, a projection module 230, a circuit unit 240 and a remote controller 250. The housing 210 has an accommodation space 212 and a containing groove 214 defined therein. The switch unit 220 is arranged in the containing groove 214, and the projection module 230 and the circuit unit 240 are arranged in the accommodation space 212. The circuit unit 240 is electrically connected to the projection module 230 and the switch unit 220. The projection module 230 includes a light source, a projection lens, and a light valve. The light valve may be a digital micro-mirror device (DMD) or a liquid crystal on silicon panel (LCOS panel). The circuit unit 240 is configured for controlling the operation of the projection module 230 according to the signals sent from the remote controller 250. In addition, the remote controller 250 is adapted to be contained in the containing groove 214 and be taken out from the containing groove 214. When the remote controller 250 is contained in the containing groove 214, the remote controller 250 contacts the switch unit 220, and the circuit unit 240 is adapted to enable and disable the projection module 230 according to the contact relation between the remote controller 250 and the switch unit 220.

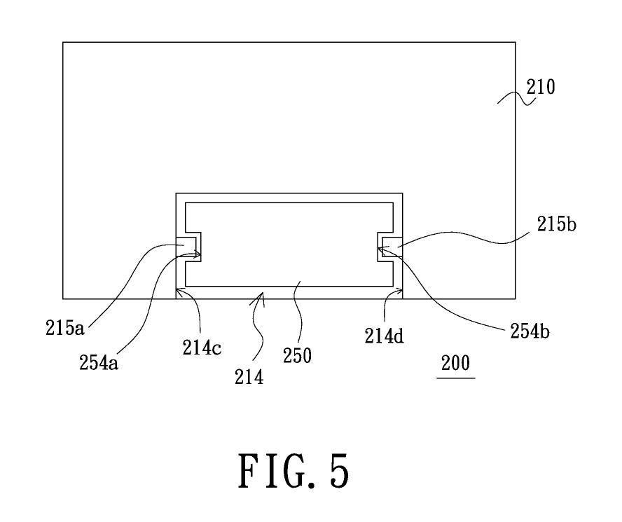

The contact relation mentioned in the above will be further described thereinafter. FIG. 4A is a schematic view showing that the remote controller is arranged out of the containing groove of the housing in accordance with an exemplary embodiment of the present invention. FIG. 4B is a schematic view showing that the remote controller is arranged in the containing groove of the housing in accordance with an exemplary embodiment of the present invention. Referring to FIGS. 3, 4A and 4B, the above switch unit 220 includes a switch element 222 arranged on a side wall 214a of the containing groove 214. In the present exemplary embodiment, the side wall 214a may be opposite to an opening 214b of the containing groove 214. In other words, the switch element 222 is opposite to the opening 214b of the containing groove 214. When the remote controller 250 is contained in the containing groove 214 (as shown in FIG. 4B), the remote controller 250 contacts the switch element 222. At this time, the circuit unit 240 disables the projection module 230. When the remote controller 250 is taken out from the containing groove 214 (as shown in FIG. 4A), the remote controller 250 does not contact the switch element 222, and the circuit unit 240 enables the projection module 230. In specific, the remote controller 250 has a contact portion 252 configured for contacting the switch element 222. In addition, the switch element 222 may be a button. When the remote controller 250 is contained in the containing groove 214, the switch element 222 is pressed by the contact portion 252 of the remote controller 250 to be in a first state (for example, in the compressed state). At this time, the circuit unit 240 electrically connected to the switch unit 220 disables the projection module 230. When the remote controller 250 is taken out from the containing groove 214, the switch element 222 is in a second state (for example, in the restitution state). At this time, the circuit unit 240 electrically connected to the switch unit 220 enables the projection module 230.

In the projection apparatus 200 of the present exemplary embodiment, since the housing 210 has the containing groove 214 configured for containing the remote controller 250, the remote controller 250 is easy to be contained to prevent the remote controller 250 from being lost. In addition, since the containing groove 214 includes the switch unit 220 arranged therein, when the user takes out the remote controller 250 from the containing groove 214, the circuit unit 240 enables the projection module 230. When the user inserts the remote controller 250 into the containing groove 214, the circuit unit 240 disables the projection module 230. Thus, the projection apparatus 200 of the present exemplary embodiment is convenient in use.

In another embodiment, the switch element 222 may be a metal sheet, and material of the contact portion 252 of the remote controller 250 may include metal. When the remote controller 250 is contained in the containing groove 214, the contact portion 252 of the remote controller 250 contacts the switch element 222. At this time, the circuit unit 240 electrically connected to the switch unit 220 disables the projection module 230. When the remote controller 250 is taken out from the containing groove 214, the switch element 222 does not contact the contact portion 252 of the remote controller 250. At this time, the circuit unit 240 electrically connected to the switch unit 220 enables the projection module 230.

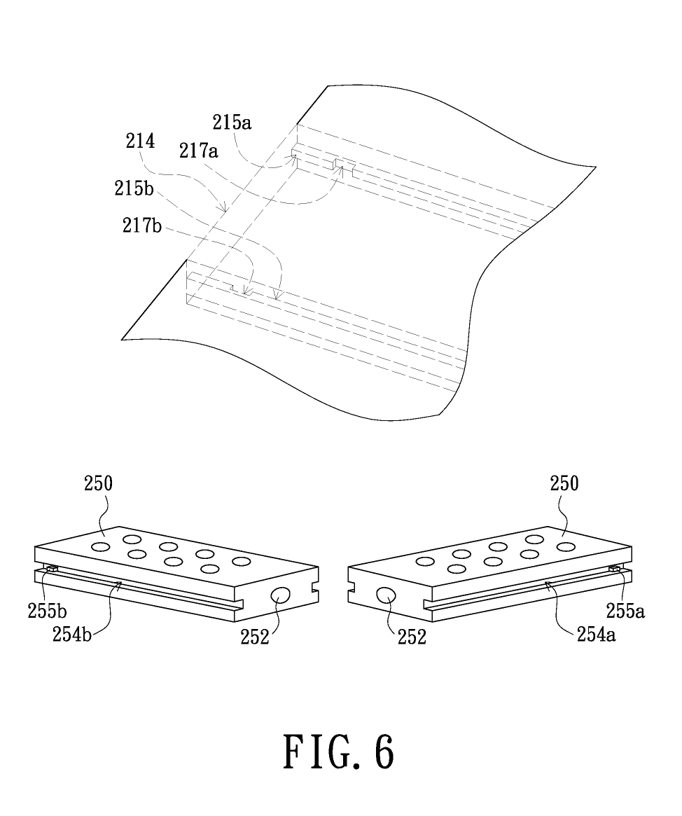

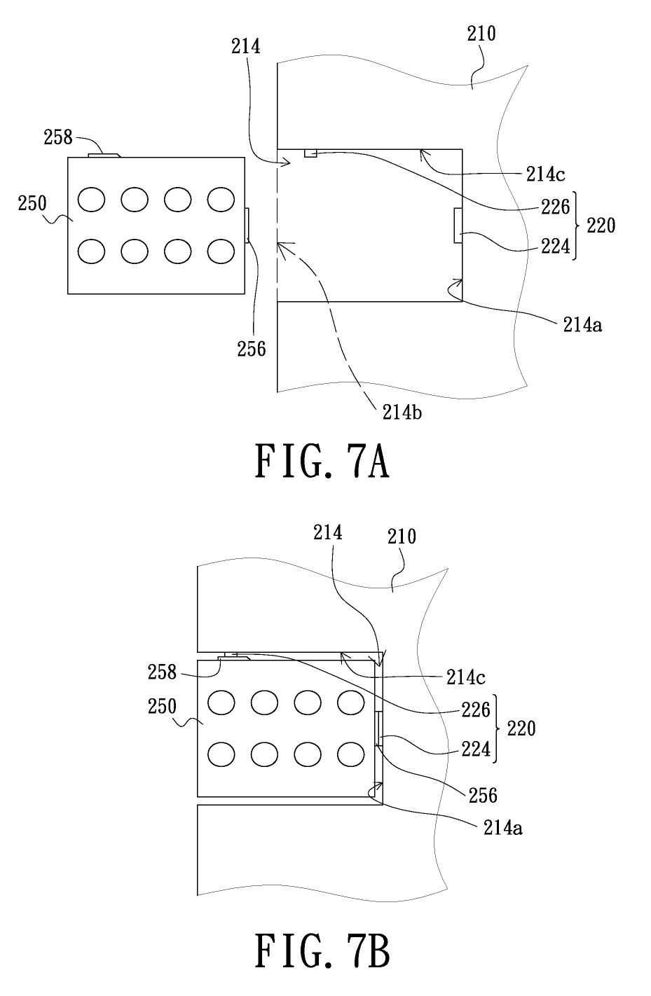

FIG. 5 is a schematic side view of the projection apparatus of FIG. 2. FIG. 6 includes two different schematic three dimensional views of the remote controller and a schematic perspective view of the containing groove of the housing in accordance with an exemplary embodiment of the present invention. Referring to FIGS. 2 and 5, in the projection apparatus 200 of the present exemplary embodiment, slide rails 215a and 215b are arranged in two opposite side walls 214c and 214d of the containing groove 214 respectively, and slide grooves 254a and 254b are arranged in two opposite side surfaces of the remote controller 250 respectively. The slide grooves 254a and 254b match the slide rails 215a and 215b. Arranging the slide grooves 254a and 254b and the slide rails 215a and 215b make the remote controller 250 is more easily to be slid into the containing groove 214. In addition, referring to FIG. 6, the slide groove 254a has a protruding portion 255a arranged therein and the slide groove 254b has a protruding portion 255b arranged therein. The slide rail 215a has a recess portion 217a arranged therein and the slide rail 215b has a recess portion 217b arranged therein. When the remote controller 250 is contained in the containing groove 214, the protruding portions 255a and 255b are clasped in the corresponding recess portions 217a and 217b to prevent the remote controller 250 from being lost.

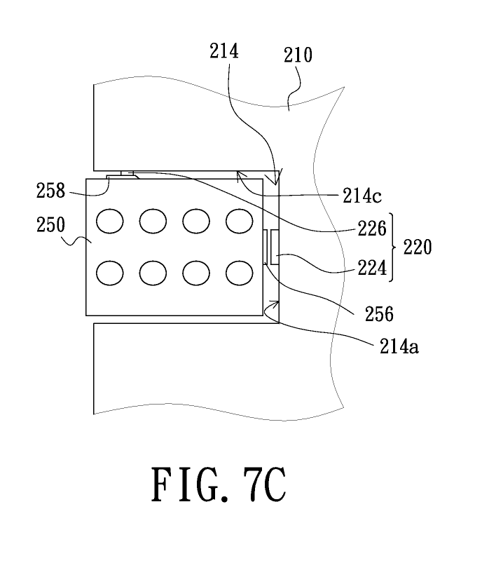

FIG. 7A is a schematic view showing that the remote controller is arranged out of the containing groove of the housing in accordance with another exemplary embodiment of the present invention. FIG. 7B is a schematic view showing that the remote controller is arranged in the containing groove of the housing in accordance with another exemplary embodiment of the present invention. FIG. 7C is a schematic view showing that a portion of the remote controller is arranged in the containing groove of the housing in accordance with another exemplary embodiment of the present invention. Referring to FIGS. 3 and 7A to 7C, in the present exemplary embodiment, the switch unit 220 includes a first switch element 224 and a second switch element 226 arranged on two side walls 214a and 214c of the containing groove 214 of the housing 210. The side wall 214a is opposite to an opening 214b of the containing groove 214. In other words, the first switch element 224 is opposite to the opening 214b of the containing groove 214.

When the remote controller 250 is contained in the containing groove 214 (as shown in FIG. 7B), the remote controller 250 contacts the first switch element 224 and the second switch element 226. At this time, the circuit unit 240 electrically connected to the switch unit 220 disables the projection module 230. When the remote controller 250 is taken out from the containing groove 214 (as shown in FIG. 7A), the remote controller 250 does not contact the first switch element 224 and the second switch element 226. At this time, the circuit unit 240 electrically connected to the switch unit 220 enables the projection module 230.

In specific, the remote controller 250 has a first contact portion 256 and a second contact portion 258. The first contact portion 256 is configured for contacting the first switch element 224, and the second contact portion 258 is configured for contacting the second switch element 226. In addition, the first switch element 224 may be a first button, and the second switch element 226 may be a second button. When the remote controller 250 is contained in the containing groove 214, the first switch element 224 and the second switch element 226 are pressed by the first contact portion 256 and the second contact portion 258 of the remote controller 250 respectively to be in a first state (for example, in the compressed state). At this time, the circuit unit 240 electrically connected to the switch unit 220 disables the projection module 230. When the remote controller 250 is taken out from the containing groove 214, the first switch element 224 and the second switch element 226 are in a second state (for example, in the restitution state). At this time, the circuit unit 240 electrically connected to the switch unit 220 enables the projection module 230.

If one of the first switch element 224 and the second switch element 226 is in the first state and the other thereof is in the second state while the projection module 230 being enabled (as shown in FIG. 7C), the projection module 230 is still enabled. If one of the first switch element 224 and the second switch element 226 is in the first state and the other thereof is in the second state while the projection module 230 being disabled (as shown in FIG. 7C), the circuit unit 240 electrically connected to the switch unit 220 enables the projection module 230.

In specific, if the user moves the remote controller 250 to switch one of the first switch element 224 and the second switch element 226 to the first state and switch the other thereof to the second state while the remote controller 250 being contained in the containing groove 214 and the projection module 230 is disabled (as shown in FIG. 7C), the circuit unit 240 electrically connected to the switch unit 220 enables the projection module 230. Therefore, if the user touches one of the first switch element 224 and the second switch element 226, the projection module 230 will be enabled.

On the other hand, if the user inadvertently touches one of the first switch element 224 and the second switch element 226 to switch one of the first switch element 224 and the second switch element 226 to the first state and switch the other thereof to the second state while the remote controller 250 being contained in the containing groove 214 and the projection module 230 being enabled (as shown in FIG. 7C), the projection module 230 is still enabled. Therefore, even if the user inadvertently touches one of the first switch element 224 and the second switch element 226, the projection module 230 is still enabled to avoid the power consumption of the projection module 230.

In another embodiment, the first switch element 224 and the second switch element 226 each may be a metal sheet, and material of the first contact portion 256 and the second contact portion 258 of the remote controller 250 each may include metal. When the remote controller 250 is contained in the containing groove 214, the first contact portion 256 and the second contact portion 258 of the remote controller 250 contacts the first switch element 224 and the second switch element 226. At this time, the circuit unit 240 electrically connected to the switch unit 220 disables the projection module 230. When the remote controller 250 is taken out from the containing groove 214, the first switch element 224 and the second switch element 226 does not contact the first contact portion 256 and the second contact portion 258 of the remote controller 250. At this time, the circuit unit 240 electrically connected to the switch unit 220 enables the projection module 230.

In summary, the projection apparatus of the embodiment of the present invention at least has the following advantages.

1. Since the housing of the projection apparatus has the containing groove configured for containing the remote controller, the remote controller is easy to be contained to prevent the remote controller from being lost.

2. Since the containing groove has the switch unit arranged therein and the circuit unit enables and disables the projection module according to the contact relation between the remote controller and the switch unit, the projection apparatus is convenient in use.

3. The slide rails are arranged in the two opposite side walls of the containing groove, and the slide grooves are arranged in the two opposite side surfaces of the remote controller. Arranging the slide grooves and the slide rails makes the remote controller more easily to be slid into the containing groove.

4. A protruding portion is arranged in the slide groove and a recess portion is arranged in the slide rail, such that the protruding portion is clasped in the recess portion to prevent the remote controller from falling while the remote controller being contained in the containing groove.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising:
a housing having an accommodation space and a containing groove;
a switch unit arranged in the containing groove;
a projection module arranged in the accommodation space;
a circuit unit arranged in the accommodation space and electrically connected to the projection module and the switch unit; and
a remote controller adapted to be contained in the containing groove and be taken out from the containing groove, wherein when the remote controller is contained in the containing groove, the remote controller contacts the switch unit, and the circuit unit enables and disables the projection module according to a contact relation between the remote controller and the switch unit.

2. The projection apparatus as claimed in claim 1, wherein the switch unit comprises a switch element arranged on a side wall of the containing groove, when the remote controller is contained in the containing groove, the remote controller contacts the switch element and the circuit unit disables the projection module, when the remote controller is taken out from the containing groove, the remote controller does not contact the switch element and the circuit unit enables the projection module.

3. The projection apparatus as claimed in claim 2, wherein the side wall of the containing groove is opposite to an opening of the containing groove.

4. The projection apparatus as claimed in claim 2, wherein the remote controller has a contact portion configured for contacting the switch element.

5. The projection apparatus as claimed in claim 4, wherein the switch element is a button, when the remote controller is contained in the containing groove, the switch element is pressed by the contact portion of the remote controller.

6. The projection apparatus as claimed in claim 4, wherein the switch element is a metal sheet and material of the contact portion comprises metal.

7. The projection apparatus as claimed in claim 1, wherein the switch unit comprises a first switch element and a second switch element arranged on two side walls of the containing groove respectively, when the remote controller is contained in the containing groove, the remote controller contacts the first switch element and the second switch element, and the circuit unit disables the projection module, when the remote controller is taken out from the containing groove, the remote controller does not contact the first switch element and the second switch element, and the circuit unit enables the projection module.

8. The projection apparatus as claimed in claim 7, wherein one of the side walls is opposite to an opening of the containing groove.

9. The projection apparatus as claimed in claim 7, wherein the remote controller has a first contact portion and a second contact portion, the first contact portion is configured for contacting the first switch element, and the second contact portion is configured for contacting the second switch element.

10. The projection apparatus as claimed in claim 9, wherein the first switch element is a first button and the second switch element is a second button, when the remote controller is contained in the containing groove, the first switch element and the second switch element are pressed by the first contact portion and the second contact portion of the remote controller respectively.

11. The projection apparatus as claimed in claim 9, wherein the first switch element and the second switch element each is a metal sheet, and material of the first contact portion and the second contact portion each comprises metal.

12. The projection apparatus as claimed in claim 1, wherein two opposite side walls of the containing groove each comprises a slide rail arranged therein, two opposite side surfaces of the remote controller each has a slide groove arranged therein, and the slide grooves match the slide rails.

13. The projection apparatus as claimed in claim 12, wherein the slide rail has a recess portion arranged therein, and the slide groove has a protruding portion arranged therein, when the remote controller is contained in the containing groove, the protruding portion is clasped in the recess portion.
